(19) United States
(12) Patent Application Publication
(10) Pub. No.: US 2026/0362567 A1
(43) Pub. Date: Nov. 12, 2026

(54) MATRIX-BASED LED LIGHTING SYSTEM

(71) Applicant: Melexis Technologies NV, Tessenderlo-Ham (BE)

(72) Inventors: Joergen STURM, Erfurt (DE); Andreas OTT, Erfurt (DE); Thomas FREITAG, Erfurt (DE); Kevin BERLIT, Erfurt (DE); Andreas LAUTE, Erfurt (DE)

(21) Appl. No.: 19/664,122

(22) Filed: Apr. 30, 2026

(30) Foreign Application Priority Data
May 7, 2025 (EP) 25174787.9

(51) Int. Cl. H05B 45/46; H05B 45/325; H05B 45/50; H05B 47/155; H05B 47/16; H05B 47/18

(52) U.S. Cl. CPC H05B 45/46; H05B 45/325; H05B 45/50; H05B 47/155; H05B 47/16; H05B 47/18

(57) ABSTRACT

A lighting system is disclosed comprising a plurality of LED driver integrated circuits. Each LED driver integrated circuit includes multiple current sources with associated PWM channels, multiple switches for selectively connecting LEDs to a power supply or ground, a synchronization interface, a communication interface, and a PWM clock generator. A plurality of LEDs is arranged in a matrix configuration, where each LED is connected between at least one current source and at least one switch. The current sources control a first dimension of the matrix, and the switches control a second dimension. The system is configured to synchronize PWM timing across all LED driver integrated circuits. One LED driver integrated circuit operates as a PWM commander that generates a synchronization signal, while the remaining LED driver integrated circuits operate as PWM responders that adjust their PWM operations based on the received synchronization signal, enabling coordinated and scalable control of the LEDs.

### FIELD OF THE INVENTION

The invention relates to the field of electronic lighting systems. More specifically it relates to a matrix-based lighting system comprising a plurality of LED driver integrated circuits.

### BACKGROUND OF THE INVENTION

In modern lighting systems, particularly those using arrays of light-emitting diodes (LEDs), efficient control of a large number of LEDs is crucial for ensuring consistent brightness, color performance, and power efficiency. One common approach for expanding the number of controllable LEDs is to use multiplexing techniques, where multiple LEDs share common driving circuitry. In such configurations, each LED driver integrated circuit (IC) typically provides a certain number of current sources and a certain number of switching elements (e.g., multiplex channels or scanning lines). The total number of addressable LEDs using one IC is thus the product of these two values.

For example, an LED driver IC equipped with 24 current sources and 4 multiplex channels can support up to 96 LEDs (24×4). This form of multiplexing enables a compact design and reduces hardware complexity for small- to medium-scale systems. However, when scaling up to support larger lighting arrays or more complex lighting scenarios, the linear growth in LED count per IC becomes a limitation-particularly from the standpoint of system efficiency, wiring complexity, and power consumption.

To overcome these limitations, it is desirable to explore architectures where multiple LED driver ICs are arranged in a matrix configuration, also referred to as a stacking approach. In such configurations, LEDs may be connected across IC boundaries, allowing for a potential non-linear (e.g., quadratic) scaling of the number of LEDs with respect to the number of ICs. This would significantly enhance the scalability and energy efficiency of the lighting system.

A key challenge that arises in matrix-based lighting systems involving multiple driver ICs is the need for precise synchronization. When multiple ICs operate independently, mismatches in timing between their respective pulse width modulation (PWM) clocks can result in visual artifacts such as flickering, ghosting, or unintended brightness fluctuations due to undesired cross-currents. Therefore, a robust synchronization strategy between the PWM channels of the various ICs becomes essential.

As such, there remains a need for a matrix lighting system in which multiple LED driver ICs are synchronized in their PWM timing.

### SUMMARY OF THE INVENTION

It is an object of embodiments of the present invention to provide a good lighting system capable of driving a large number of LEDs.

The above objective is accomplished by a method and device according to the present invention.

In a first aspect, embodiments of the present invention relate to a lighting system comprising a plurality of LED driver integrated circuits. Each LED driver integrated circuit comprises a plurality of current sources and each current source has an associated pulse width modulation channel. Each LED driver integrated circuit, moreover, comprises a plurality of switches for selectively connecting LEDs to a power supply or ground. Each LED driver integrated circuit, moreover, comprises a synchronization interface, a communication interface, and a PWM clock generator configured to provide a timing signal to the PWM channels.

The lighting system further comprising a plurality of LEDs arranged in a matrix configuration. Each LED is connected between at least one current source from the LED driver integrated circuits and at least one switch from the LED driver integrated circuits. The PWM channel is configured to control current flow through one of the LEDs. The current sources of the plurality of LED driver integrated circuits control a first dimension of the matrix configuration, and the switches control a second dimension of the matrix configuration.

The lighting system is configured to synchronize PWM timing across the plurality of LED driver integrated circuits, wherein one LED driver integrated circuit is configured as a PWM commander to generate a synchronization signal and remaining LED driver integrated circuits are configured as PWM responders to adjust the PWM operation based on the received synchronization signal. The PWM commander may generate the synchronization signal using its PWM clock generator. The PWM responders may adjust the PWM operation of their PWM clock generator or may adjust the PWM ratio based on the received synchronization signal.

It is an advantage of embodiments of the present invention that PWM synchronization across LED driver ICs avoids flickering and ghosting effects in a matrix arrangement.

It is another advantage of embodiments of the present invention that the matrix configuration allows scalable LED control beyond the linear scaling limitations of individual LED driver ICs.

It is a further advantage of embodiments of the present invention that the synchronization signal allows coordinated PWM operation even with decentralized PWM generators in each IC.

In embodiments of the present invention, the number of LEDs controllable by the lighting system scales with the number of LED driver integrated circuits according to the formula n²×LC×M, assuming that each LED driver integrated circuit comprises the same number LC of current sources and the same number M of switches.

It is an advantage of embodiments of the present invention that the number of controllable LEDs scales quadratically with the number of ICs, reducing per-LED cost and energy consumption.

In embodiments of the present invention, the lighting system further comprises an electronic control unit connected to the communication interfaces of the plurality of LED driver integrated circuits. The electronic control unit is configured to assign one LED driver integrated circuit as the PWM commander and to assign the remaining LED driver integrated circuits as the PWM responders.

In embodiments of the present invention, the PWM commander is configured to generate the synchronization signal with a frequency and a pulse length related to its PWM clock generator, and each PWM responder is configured to synchronize the operation of its current sources and switches according to the received synchronization signal.

It is an advantage of embodiments of the present invention that PWM synchronization can be dynamically adjusted using pulse length encoding.

In embodiments of the present invention, each LED driver integrated circuit further comprises a discharge circuit connected in parallel to each current source. The discharge circuit is configured to remove residual charges from the matrix configuration during a discharge phase synchronized with the synchronization signal.

It is an advantage of embodiments of the present invention that residual charges are removed in a controlled and coordinated manner, reducing the risk of cross-currents or unintended LED activation, such as ghost images in LED matrices.

In embodiments of the present invention, each LED driver integrated circuit is configured to perform diagnostics on connected LEDs during an off phase and to communicate diagnostic results via the communication interface. In one embodiment, this off phase includes a designated discharge phase. In embodiments of the present invention the off phase refers to a time period during which an LED or LED string is not actively driven by a current source, and no light emission is intended. This includes, but is not limited to, the discharge phase and other intervals within a PWM cycle or outside it when the current source is disabled.

It is an advantage of embodiments of the present invention that diagnostic functionality is integrated and coordinated with the PWM cycle, increasing reliability and testability of the system.

In embodiments of the present invention, each PWM responder is configured to measure a pulse length of the received synchronization signal and adjust at least one of its PWM clock generator frequency or PWM ratios of its current sources based on the measured pulse length.

It is an advantage of embodiments of the present invention that clock drift or frequency deviations between ICs can be compensated in real time.

In embodiments of the present invention, the PWM commander is configured to encode additional information in the synchronization signal by varying the pulse length, and the PWM responders are configured to decode the additional information.

It is an advantage of embodiments of the present invention that the synchronization signal can carry control or configuration data, minimizing the need for additional communication lines.

In embodiments of the present invention, the LED driver integrated circuits are configured to control the rows and columns of the matrix configuration in a non-sequential order to reduce systematic errors.

It is an advantage of embodiments of the present invention that non-sequential control helps to minimize visible artifacts in the output of the lighting system.

In a second aspect, embodiments of the present invention relate to an LED driver integrated circuit for use in a matrix lighting system comprising a plurality of LEDs arranged in a matrix configuration.

The LED driver integrated circuit comprises a plurality of current sources, each current source having an associated pulse width modulation channel, a plurality of switches for selectively connecting LEDs to a power supply or ground, a PWM clock generator configured to provide a timing signal to the PWM channels, a synchronization interface. The synchronization interface is configured to operate in a PWM commander mode to generate and output a synchronization signal based on the PWM clock generator or in a PWM responder mode to receive a synchronization signal and adjust operation of the PWM channels based on a received synchronization signal.

The LED driver integrated circuit, furthermore, comprises a PWM adjustment unit configured to, in the PWM responder mode, measure a pulse length of the received synchronization signal and adjust at least one of the PWM clock generator frequency or PWM ratios based on the measured pulse length.

In such an LED driver integrated circuit the current sources are configured to drive one or more LEDs of the matrix lighting system and the switches are configured to connect one or more LEDs of the matrix lighting system to a power supply or ground.

It is an advantage of embodiments of the present invention that the LED driver IC can flexibly assume either a PWM commander or PWM responder role, facilitating modular and scalable lighting systems.

It is another advantage of embodiments of the present invention that the IC integrates both current control and switch control for matrix LED configurations.

In embodiments of the present invention, the LED driver integrated circuit further comprises a discharge circuit connected in parallel to each of the current sources. The discharge circuit is configured to activate during intervals between PWM cycles to remove residual charges from connected LEDs.

It is an advantage of embodiments of the present invention that charge removal is locally managed within each IC without external coordination.

In embodiments of the present invention, the synchronization interface is further configured to encode or decode multiple information types based on different pulse lengths of the synchronization signal.

It is an advantage of embodiments of the present invention that the IC can interpret multiple control signals from a single synchronization line, improving communication efficiency.

In a third aspect, embodiments of the present invention relate to a method of operating a lighting system comprising a plurality of LED driver integrated circuits arranged in a matrix configuration.

The method comprises:
configuring one LED driver integrated circuit as a pulse width modulation PWM commander—configuring remaining LED driver integrated circuits as PWM responders,
generating by the PWM commander a synchronization signal based on a PWM clock of the PWM commander,
receiving by each PWM responder the synchronization signal,
synchronizing PWM timing of current sources in each PWM responder based on the received synchronization signal,
controlling a first dimension of a matrix of LEDs using current sources from the plurality of LED driver integrated circuits,
and controlling a second dimension of the matrix of LEDs using switches from the plurality of LED driver integrated circuits, wherein each LED in the matrix is connected between at least one current source of the LED driver integrated circuits and at least one switch of the LED driver integrated circuits.

It is an advantage of embodiments of the present invention that PWM timing is synchronized across a matrix arrangement of ICs while maintaining distributed control over LED operation.

In embodiments of the present invention, the method further comprises:
activating a discharge cycle between PWM cycles,
activating discharge circuits during the discharge cycle to remove residual charges from the LEDs,
and ensuring all current sources are deactivated before switching states of any switches.

It is an advantage of embodiments of the present invention that switching is coordinated to prevent cross-currents or unintended activations.

In embodiments of the present invention, the method further comprises:
measuring a pulse length of the synchronization signal at each PWM responder,
calculating a clock frequency deviation between the PWM commander and each PWM responder based on the measured pulse length,
and adjusting PWM operation in each PWM responder to compensate for the calculated deviation.

It is an advantage of embodiments of the present invention that the method allows real-time correction for clock drift, increasing timing accuracy and system robustness.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 is a schematic diagram of a matrix configuration of LEDs controlled by LED driver integrated circuits controlling high-side supply switches and low-side current sources according to embodiments of the present invention.

FIG. 2 is a timing diagram illustrating control of multiplexers in an LED driver integrated circuit with software-assigned switch order according to embodiments of the present invention.

FIG. 3 is a block diagram of a lighting system comprising multiple LED driver integrated circuits connected to a communication bus and synchronization line according to embodiments of the present invention.

FIG. 4 is a schematic diagram of a lighting system with LEDs arranged in an x/y matrix with rows and columns according to embodiments of the present invention.

FIG. 5 is a block diagram illustrating the internal architecture of an LED driver integrated circuit according to embodiments of the present invention.

FIG. 6 is a flowchart illustrating a method of operating a lighting system, comprising a plurality of LED driver integrated circuits arranged in a matrix configuration, according to embodiments of the present invention.

Any reference signs in the claims shall not be construed as limiting the scope.

In the different drawings, the same reference signs refer to the same or analogous elements.

### DETAILED DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

The terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Where in embodiments of the present invention reference is made to “pulse width modulation (PWM)” reference is made to a modulation technique used to control the effective power delivered to a load by varying the duty cycle of a periodic signal. In the context of LED driving, PWM is applied to regulate brightness by switching current on and off at a frequency typically above human visual perception. Examples include using PWM signals at various frequencies (e.g., hundreds of hertz to kilohertz range) to dim LEDs in lighting systems or LED displays.

Where in embodiments of the present invention reference is made to a “PWM channel” reference is made to a control channel associated with a current source that uses PWM to drive a particular LED or string of LEDs. An example would be a single channel in a multi-channel LED driver integrated circuit that independently sets the on/off duty cycle for a specific LED row or column.

Where in embodiments of the present invention reference is made to “switch for selectively connecting LEDs to a power supply or ground” reference is made to a controllable electronic component, such as a transistor or MOSFET, within the LED driver integrated circuit used to open or close a circuit path to power or ground.

Where in embodiments of the present invention reference is made to a “synchronization interface” reference is made to the functional capability of an LED driver integrated circuit to transmit and/or receive synchronization signals for coordinating PWM operation with other LED driver integrated circuits, regardless of the specific physical implementation of the interface.

Where in embodiments of the present invention reference is made to a “communication interface” reference is made to the hardware and protocol mechanisms within an LED driver integrated circuit for sending and receiving data, instructions, or configurations with external devices or other driver ICs. Examples include serial interfaces (e.g. SPI, I2C) or proprietary bus interfaces (e.g. LIN, CAN, CANFD, UART over CAN) that enable control and diagnostic information exchange.

Where in embodiments of the present invention reference is made to a “PWM clock generator” reference is made to a timing circuit or oscillator within an LED driver integrated circuit that produces a stable reference clock for generating PWM signals. Examples include internal oscillators, such as RC oscillators, running at a specified frequency, external clock inputs used to lock to a system clock, or clock generators using techniques such as Phase-Locked Loops (PLL).

Where in embodiments of the present invention reference is made to a “timing signal” reference is made to any periodic or pulsed output from the PWM clock generator or from a synchronization interface that serves as a reference for coordinating PWM on/off cycles. Examples include a square wave output from the clock generator or a synchronization pulse transmitted across multiple driver ICs to align their PWM phases.

Where in embodiments of the present invention reference is made to a “discharge circuit” reference is made to an electrical path that, when activated, removes or drains any accumulated charge in the LED circuit or matrix lines. Examples include resistor-based or transistor-based discharge paths that evacuate unwanted electrical energy between PWM cycles, preventing ghost illumination.

Where in embodiments of the present invention reference is made to a “pulse length” reference is made to the duration of the active high or active low portion of a synchronization signal or PWM signal, typically measured in nanosecond, microseconds or milliseconds. Examples include fixed pulse lengths used strictly for synchronization or variable pulse lengths that may encode additional information, such as commands or configuration data.

The terms “multiplexer,” “LED switch,” and “LED supply switch” are used interchangeably throughout this description. Each refers to a switch or switching element that selectively connects an LED or LED string to a power supply or ground, thereby enabling multiplexed control of LEDs in a matrix configuration.

In a first aspect, the present invention relates to a lighting system (100) comprising: a plurality of LED driver integrated circuits (110), each LED driver integrated circuit (110) comprising: a plurality of current sources (111), each current source (111) having an associated PWM channel; a plurality of switches (112) for selectively connecting LEDs to a power supply or ground; a synchronization interface (113); a communication interface (114); a PWM clock generator (115) configured to provide a timing signal to the PWM channels; a plurality of LEDs (120) arranged in a matrix configuration (130), wherein each LED (120) is connected between at least one current source (111) from the LED driver integrated circuits (110) and at least one switch (112) of the LED driver integrated circuits (110) and wherein the PWM channel is configured to control current flow through one of the LEDs or string of LEDs; wherein the current sources (111) of the plurality of LED driver integrated circuits (110) control a first dimension of the matrix configuration (130), and the switches (112) control a second dimension of the matrix configuration (130); and wherein the lighting system (100) is configured to synchronize PWM timing across the plurality of LED driver integrated circuits (110), wherein one LED driver integrated circuit (110) is configured as a PWM commander to generate a synchronization signal and the remaining LED driver integrated circuits (110) are configured as PWM responders to adjust the PWM operation based on the received synchronization signal.

The invention assumes the presence of multiple LED driver integrated circuits, each comprising one or more switches for selectively connecting an LED to a power supply or ground, and one or more current sources for driving an LED, the current sources being controlled by pulse width modulation (PWM). Each of these integrated circuits is connected to an external controller, such as an electronic control unit (ECU), via a communication interface. This interface may include, for example, protocols such as LIN, CAN, CAN FD, or UART over CAN. The communication interface enables the delivery of PWM control data for each LED associated with a respective integrated circuit. It should be noted that such communication does not necessarily provide synchronization data between the integrated circuits. In some cases, it may provide general control data such as a common start signal or frame-based instructions, but such synchronization information is not essential for implementing the invention.

The LEDs may be driven individually or configured in strings. These strings may include LEDs connected in series, in parallel, or in a combination of both, depending on the embodiment.

In the lighting system, pulse width modulation (PWM) timing is synchronized across multiple LED driver integrated circuits (ICs) using a distributed coordination scheme. One of the LED driver ICs is configured to operate as a PWM commander, while the remaining ICs act as PWM responders. The PWM commander generates a synchronization signal, such as a timing pulse or slot start signal, which is transmitted over a shared synchronization interface (e.g., a wired line or serial bus). The PWM responders receive this synchronization signal through their respective synchronization interfaces and adjust their internal PWM timing accordingly. This setup ensures that all PWM channels across the matrix of LEDs operate in a time-aligned manner, thereby preventing timing skew and enabling coherent control of LED brightness and dynamic light effects. The synchronization signal can be generated by the PWM clock generator of the PWM commander IC and distributed at regular intervals, for instance at the beginning of each PWM cycle. The designation of the PWM commander can be static, or dynamically negotiated during system initialization or based on preconfigured priorities.

The current sources may be implemented internally within the integrated circuits or externally, using circuitry that generates current through the LEDs under control of a PWM signal. The physical placement of the switches—whether on the high side (near the power supply) or low side (near ground)—and the location of the current sources—whether referenced to supply or ground—is not limited. Likewise, the number of switches and current sources per integrated circuit is not restricted.

Each integrated circuit further comprises at least one connection used for synchronization with other integrated circuits. This connection may be a simple direct electrical connection or may be implemented using logical communication protocols capable of rapidly exchanging PWM cycle information.

Each integrated circuit is configured to control a plurality of switches and a plurality of current source outputs. The current sources may be referenced to either supply voltage or ground.

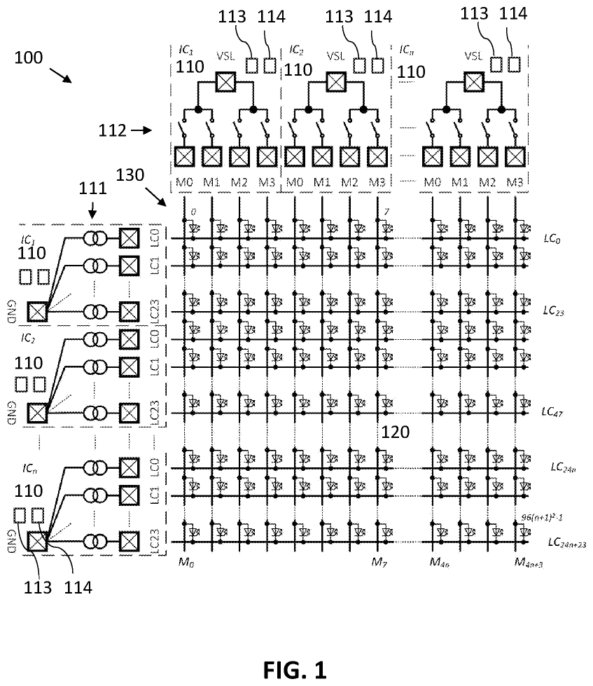

There is no fixed requirement that an integrated circuit must control both the current source and the switch associated with any particular LED. In fact, it is an aspect of the invention that one integrated circuit may control switches connected to LEDs for which the current is sourced by another integrated circuit. Conversely, an integrated circuit may control current sources associated with LEDs whose switching elements are controlled by other integrated circuits. This decoupling of control functions across devices enables flexible matrix arrangements and is illustrated in, for example, FIG. 1.

It is noted that the matrix configuration is not limited to a one-to-one correspondence between a current source or switch and an LED. In some implementations, two or more current sources may be configured to drive the same LED or LED string. This may be done, for example, to increase the total output current and thereby increase the light intensity of the corresponding LED. Similarly, multiple switches may be connected in parallel to drive the same node of the matrix. This configuration can be advantageous for reducing the resistance in the switching path, thereby improving power efficiency and thermal performance. In particular, using multiple switches in parallel may reduce the overall on-resistance of the system, contributing to more efficient current conduction and lower heat generation.

Such flexible arrangements are within the scope of the described matrix-based architecture, where rows and columns are controlled respectively by switches and current sources (or vice versa), and LEDs are located at crossing points between these control paths. The described system architecture allows for scalability and current-sharing techniques to meet various brightness and efficiency requirements.

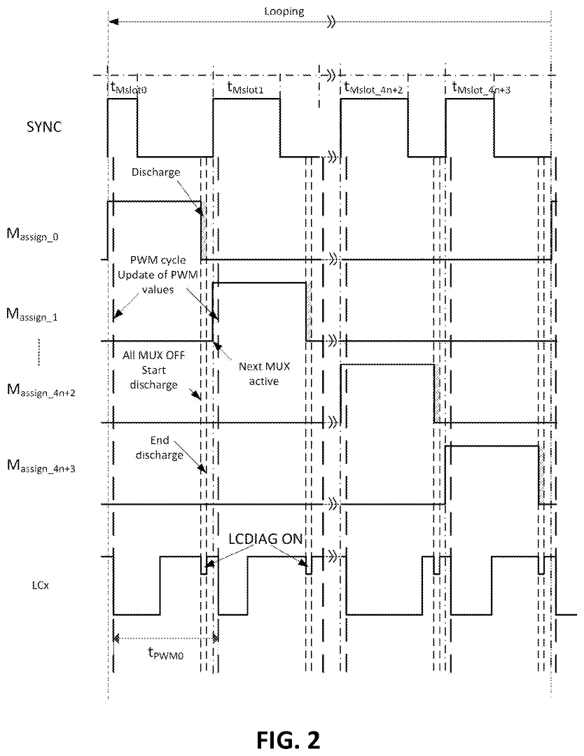

In embodiments of the present invention the switches may change their state (either turning ON or OFF) only when all LEDs connected to the respective switch—i.e., all LEDs in a string that is connected via that switch to a supply or to ground—are in the OFF state. Since the ON/OFF state of each LED is controlled by the pulse width modulation (PWM) signal applied to the corresponding current source, this implies that all PWM channels associated with the LEDs in that string are in that case simultaneously in an OFF state (see FIG. 2).

An OFF state can be realized either by applying a zero PWM duty cycle to the current source driving the LED string, or by disabling the current source via an analog control method.

In embodiments of the present invention the following synchronization scheme may be implemented under the following assumptions:

A first LED driver integrated circuit (IC1) may be designated as the PWM commander, with the remaining ICs operating as PWM responders. Alternatively, the assignment of PWM commander and PWM responders may be carried out by the ECU.

Each IC may comprise multiple local PWM generators, for example, one per LED driver output, operating in synchronization within the IC.

The ECU may provide per-frame image data, and/or control instructions for switching sequences, and/or a start signal to all ICs via the communication interface. In embodiments of the present invention synchronization of PWM timing across ICs is handled independently from the ECU.

In embodiments of the present invention all ICs may operate with identical PWM settings in terms of frequency and period.

In a preferred embodiment of the present invention a hardware-based synchronization signal is utilized as follows.

PWM operation across all ICs is synchronized at the beginning of each PWM period (preferably by hardware).

The switching of supply or ground paths is performed once per PWM period (by software or hardware).

The PWM commander generates a synchronization signal that is transmitted to all PWM responders.

PWM responders use, for instance, the rising edge of the synchronization signal to synchronize the start of their local PWM cycles (preferably in hardware).

The PWM responders may, for instance, also use the falling edge of the synchronization signal to determine the deviation between their own local PWM clock and that of the PWM commander. Based on this deviation, each PWM responder may calculate a timing offset to adjust its PWM operation. Since each IC's clock source may be implemented using RC oscillators, timing deviations of approximately ±3% from the nominal frequency may occur under typical environmental conditions (e.g., at room temperature).

The synchronization signal may also encode additional synchronization data using variable pulse lengths, such as signals marking the end of a line (horizontal sync) or the end of a frame (vertical sync) in display-type matrix arrangements.

In embodiments of the present invention the following hardware features may, for example, be present:
Hardware support in each PWM responder to synchronize PWM start events;
Measurement circuitry to measure the clock shift between the PWM commander and each PWM responder. This may for example comprise a counter measuring the timing difference (positive or negative) between PWM start and end signals. This may for example be a reverse-counting PWM timer. Alternatively a method may be used for capturing the SYNC timing into a register and calculating the delta based on its value (e.g., if the value is greater than 50% of the maximum counter, then delta=2\hat{ }16—captured value; otherwise, delta=captured value).

This clock shift information may be used to adapt either: the local clock frequency of the PWM responder (e.g., using phase-locked loop or delay-locked loop hardware); or the ON-time duration of the PWM output directly, compensating via adjusted duty cycles to maintain the intended light intensity or color.

In embodiments of the present invention the synchronization signal is directly driven by the PWM commander. In embodiments of the present invention its rising and falling edges are configurable to account for signal propagation and sampling delays.

On the PWM responder side, the SYNC input is preferably routed to a timer-capture unit. In a particularly advantageous embodiment, two separate timers are employed: one to determine the PWM timing shift relative to the PWM commander (due to RC oscillator differences), and another to measure the synchronization signal pulse width to extract any encoded high-level synchronization data (e.g., horizontal or vertical sync indicators in a display-style layout).

FIG. 1 shows a matrix configuration (130) of LED driver integrated circuits (110) controlling high-side supply switches (112) and low-side current sources (111). The diagram depicts multiple LED driver integrated circuits (IC1, IC2, . . . , ICn) each connected to a supply voltage (VSL) and ground (GND). Each integrated circuit (110) comprises a set of switches (112) connected to the supply voltage, and a set of current sources (111) connected to ground. The switches (112) are arranged in parallel, each controlling a separate line leading to a matrix of LEDs (120). The current sources (111) are similarly arranged in parallel, each controlling a separate line leading from the matrix of LEDs (120). The matrix configuration (130) is shown with rows and columns, where each intersection represents an LED (120). The LEDs (120) are connected between the switches (112) and current sources (111), forming a grid-like structure. The diagram further illustrates the scalability of the system, with the number of LEDs (120) increasing quadratically with the number of integrated circuits (110). The configuration allows for complex lighting scenarios by individually controlling the brightness and color of each LED (120) through the PWM channels associated with each current source (111). In embodiments of the present invention each current source is controlled by an individual PWM channel. In embodiments of the present invention the current may also be adjusted via an analog way. The arrangement ensures efficient power distribution and synchronization across the integrated circuits (110), contributing to the overall functionality of the lighting system (100).

In embodiments of the present invention, the number of LEDs (120) controllable by the lighting system (100) may scale with the number (n) of LED driver integrated circuits (110) according to the formula n²×LC×M, where LC is the number of current sources (111) per LED driver integrated circuit (110) and M is the number of switches (112) per LED driver integrated circuit (110), supposing that LC and M are equal for the LED driver integrated circuits (110). This provides a quadratic scaling of the number of controllable LEDs (120), which significantly increases the efficiency and capability of the lighting system (100). In the example 24 current sources are related to ground (GND) (LC0 . . . LC23) and each LED driving IC comprises a number of M=4 switches related to the LED supply VSL (M0 . . . . M3). The table below shows the number of LEDs or LED strings in function of the number of LED driving ICs, current sources and switches.

| Number of LED | Number of Current | Number of Switches | |
|---|---|---|---|
| driving ICs n | Sources LC per IC | M per IC | #LEDs |
| 1 | 3 | 4 | 12 |
| 2 | 3 | 4 | 48 |
| 3 | 3 | 4 | 108 |
| 4 | 3 | 4 | 192 |
| 4 | 24 | 4 | 1536 |

FIG. 1 and the table above demonstrate that the invention might be used in display like arrangements, where picture-like lighting scenarios should be displayed.

In embodiments of the present invention, the lighting system (100) may further comprise an electronic control unit (ECU) (150) connected to the communication interfaces (114) of the plurality of LED driver integrated circuits (110), the ECU (150) configured to assign one LED driver integrated circuit (110) as the PWM commander and to assign the remaining LED driver integrated circuits (110) as the PWM responders. This centralized control architecture enables efficient management of the entire lighting system (100) from a single point.

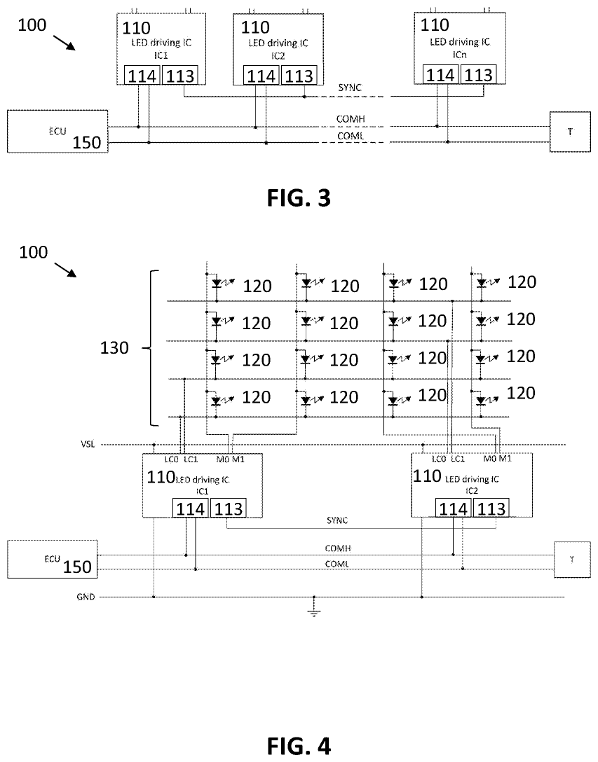

FIG. 3 shows a lighting system (100) comprising multiple LED driving integrated circuits (110) connected to a communication bus and a synchronization line associated with the synchronization interface (113). The system includes an electronic control unit (ECU) (150) connected to a series of LED driving integrated circuits (110) labeled as IC1, IC2, and ICn. Each LED driving integrated circuit (110) is connected to a synchronization line labeled “SYNC” that facilitates the coordination of PWM signals across the integrated circuits (110). Additionally, the communication bus is depicted with two lines labeled “COMH” and “COML,” connected with the differential communication interfaces (114) of the different ICs (110). In other embodiments, a single line interface such as a Local Interconnect Network (LIN) interface may be used. A termination device, represented by “T,” is connected to the communication bus, ensuring proper signal integrity. The arrangement of the LED driving integrated circuits (110) and the ECU (150) demonstrates a structured approach to managing and synchronizing LED (120) operations within the lighting system (100). The differential bus may for example be a CAN bus or any other proprietary bus. One of the LED driving ICs might be assigned by the ECU as a PWM commander, all other LED driving ICs might be assigned as PWM responders.

In embodiments of the present invention, the PWM commander may generate the synchronization signal with a frequency and a pulse length related to its PWM clock generator (115), and wherein each PWM responder is configured to synchronize the operation of its current sources (111) and switches (112) according to the received synchronization signal.

FIG. 4 shows the lighting system (100) of FIG. 3 with LEDs (120) arranged in an x/y matrix with rows and columns according to embodiments of the present invention. The diagram depicts two LED driving integrated circuits (110) (IC1 and IC2), each connected to a series of LEDs (120). The LEDs (120) are organized in a matrix configuration (130), with each LED (120) positioned at the intersection of rows and columns. The LED driving integrated circuits (110) are responsible for controlling the current sources (111) and switches (112) that manage the flow of current through the LEDs (120). The LED driving integrated circuits (110) are connected to a power supply line labeled VSL and a ground line labeled GND. The synchronization line, labeled SYNC, connects the ICs via the synchronization interface (113), facilitating the coordination of PWM signals across the system. Additionally, the system includes a communication bus with high (COMH) and low (COML) lines connecting the ICs (110) to an electronic control unit (ECU) (150) and a termination device (T). The arrangement allows for the control of the LEDs (120) in a matrix format (130), where the current sources (111) manage one dimension (e.g., rows) and the switches (112) manage the other dimension (e.g., columns). This configuration enables complex lighting scenarios by synchronizing the PWM operation of the current sources and the operation of the switches across the integrated circuits (110), ensuring precise control over the brightness and color of each LED (120). The synchronization is advantageous to prevent flickering and ensure a harmonious display of lighting effects.

In embodiments of the present invention, each LED driver integrated circuit (110) may further comprise a discharge circuit (117) connected in parallel to each current source (111), the discharge circuit (117) configured to remove residual charges from the matrix configuration (130) during a discharge phase synchronized with the synchronization signal from the synchronization interface (113). This prevents unwanted glowing of LEDs (120) and improves the visual quality of the lighting display.

In embodiments of the present invention, each LED driver integrated circuit (110) may perform diagnostics on connected LEDs (120) during an off phase and communicate diagnostic results via the communication interface (114). This allows for real-time detection of failures like broken connections without requiring additional diagnostic cycles. In one embodiment, the off phase includes a designated discharge phase. Diagnostics may include, for example, temperature measurements, while other types of diagnostics are not excluded.

FIG. 2 shows a timing scheme for controlling four multiplexers within a single integrated circuit (110), where the switch order is assigned by software. The figure illustrates the control of an individual LED or LED string by a combination of one or more switches or multiplexers (M) and a current source (LCx). To prevent parasitic flickering of the LED, the switches should only change their state when the LED is turned off, which corresponds to the current source LCx being in a HIGH state. In embodiments of the present invention the assignment of switches to control specific LEDs is managed via software, allowing flexibility and adaptability to different matrix configurations. The switches may be located within the same LED driver IC as the current source LCx or may reside in a separate IC, as depicted for example in FIG. 1. More than one current source and more than one switch might be active in time. This allows to handle complex lighting scenarios.

The diagram depicts a series of timing slots labeled as t_Mslot0, t_Mslot1, t_Mslot_4n+2, and t_Mslot_4n+3, indicating the sequential activation of multiplexers. The synchronization signal (SYNC) from the synchronization interface (113) is shown as a waveform that initiates the discharge phase, followed by the PWM cycle from the PWM clock generator (115) and the update of PWM values. The multiplexers, labeled as M_assign_0, M_assign_1, M_assign_4n+2, and M_assign_4n+3, are depicted as horizontal lines that transition between active and inactive states.

The diagram indicates that all multiplexers are turned off to start the discharge phase, which is advantageous to remove residual charges from the interconnection lines to the LEDs of the matrix from a previous PWM period. The next multiplexer is activated after the discharge phase, ensuring that the LEDs (120) do not flicker. After the switch transition a new PWM cycle with possibly new updated PWM values for the current source LCx starts.

The LCx line represents the current source (111), which is controlled by the PWM signal from the PWM clock generator (115). The PWM cycle is shown with a specific period t_PWM0, and the LCx line transitions between high and low states, corresponding to the ON and OFF states of the LED (120).

During the discharge time also a diagnosis cycle might be done in order to check that a given LED or LED string is still correctly connected to a given LED channel and a given multiplexer. This might be useful in order to check for e.g. lost solder connections. For diagnosing, the voltage and/or current during the diagnosis cycle might be monitored regarding a given threshold. If a failure is detected, this might be communicated via the communication interface to the ECU. The LCDIAG ON signal is depicted, indicating a diagnostic phase where the system (100) checks the connectivity and functionality of the LEDs (120).

The timing scheme ensures that the multiplexers switch states only when the LEDs (120) are off, preventing parasitic flickering and ensuring smooth operation of the lighting system (100). The synchronization of the PWM cycle from the PWM clock generator (115) with the synchronization signal from the synchronization interface (113) allows for precise control of the LED matrix (130), contributing to the overall functionality and reliability of the invention.

In an exemplary embodiment of the present invention the lighting scenarios are defined by the ECU. In such an embodiment all LED driving ICs may receive PWM information for their current sources as well as switch information via the communication interface. The synchronization signal may arrange in a PWM commander/PWM responder approach the timing for updating the PWM values for the related current sources and the timing for operating the switches. In the said PWM commander/PWM responder approach, the PWM commander is generating the synchronization signal, while all PWM responders receive the synchronization signal and respond in their operation to this received signal.

In an alternative embodiment the LED lighting scenarios or a part of these scenarios are stored in the LED driving ICs. The ECU sends via the communication interface only information, what lighting scenario is actually active. Also, here the synchronization signal only arranges in a PWM commander/PWM responder approach the timing for updating the PWM values of the related current sources and the timing for operating the switches.

Based on the individual addresses of the LED driving ICs connected to the ECU, the ECU might assign one LED driving IC being the PWM commander while all other LED driving ICs are PWM responders.

In embodiments of the present invention, each PWM responder may measure a pulse length of the received synchronization signal from the synchronization interface (113) and adjust at least one of its PWM clock generator (115) frequency or PWM ratios of its current sources (111) based on the measured pulse length. This compensates for clock frequency variations between different ICs (110), ensuring uniform brightness and color across the entire display.

In embodiments of the present invention, the PWM commander may encode additional information in the synchronization signal from the PWM clock generator (115) by varying the pulse length, and wherein the PWM responders are configured to decode the additional information.

In embodiments of the present invention, a lighting system (100) may employ the synchronization signal from the synchronization interface (113) for security or authentication. For example, the PWM commander (110) may vary the synchronization signal over multiple PWM periods to transfer authentication or security information to the PWM responders (110), allowing the PWM responders to verify system integrity before executing any lighting commands.

In embodiments of the present invention, each PWM responder (110) may be configured to monitor specific timing characteristics of the synchronization signal from the synchronization interface (113)—such as pulse patterns or durations—in order to detect a predefined sequence. Upon recognizing this sequence, the PWM responders (110) may confirm that the PWM commander (110) is authorized and proceed with normal lighting operations.

In a lighting system (100), according to embodiments of the present invention, comprising multiple LED driver ICs (110) and an electronic control unit (ECU) (150), the ECU (150) may designate one LED driver IC (110) as the PWM commander. Over a series of synchronization pulses from the PWM clock generator (115), the PWM commander (110) may encode a cryptographic key by modulating the duration of each pulse according to a stored security pattern. Each PWM responder (110) may use a hardware counter to measure both rising and falling edges of the incoming synchronization pulses from the synchronization interface (113). The PWM responders (110) may then reconstruct the cryptographic key from this timing data and compare it with a locally stored reference key. Only if the keys match do the PWM responders (110) unlock full PWM functionality, thereby ensuring that unauthorized or tampered PWM commanders (110) cannot drive the LED matrix (130). In security relevant light architectures as e.g., tail light, fog or front light of a car this might be needed. This behavior unloads the communication interface between the ECU and all LED driving ICs from diagnostic tasks, which might allow a higher data rate for light information provided from the ECU to the LED driving ICs.

In embodiments of the present invention, pulse length encoding might be used for PWM frequency calibration between the LED driver integrated circuits (110). Therefore, discrete pulse lengths may be used. Discrete pulse length levels, such as ⅓, ½, and ⅔ of the SYNC period, allow a PWM calibration of PWM responder ICs. Longer pulse lengths improve the measurement accuracy by reducing the impact of the transition slopes from HIGH to LOW and vice versa. The PWM clock between the LED driving ICs might differ. Based on the known length of the SYNC pulse, the PWM responder ICs can calculate the mismatch of their own PWM clocks compared to the PWM clock of the PWM commander and might recalibrate their local PWM clock. This could be a recalibration of the PWM clock generator as well as a compensation of the PWM ratio in order to achieve the best possible match to the requested PWM ratio to be displayed.

In embodiments of the present invention, pulse length encoding might be used for image/frame synchronization. Furthermore, the calibration can encompass the entire switch cycle for even greater accuracy, albeit with increased measurement time.

In embodiments of the present invention SYNC slots may be assigned logically by software to the switches independent of their physical location (i.e. in which IC is the switch, what is its physical order). This can enable e.g. randomization, further enhancing security and reducing systematic errors. Randomization means in that context not to control the switches in a predefined sequence (e.g. increasing indices 1, 2, 3, 4 . . . ), but in a random order. Assuming the switches to define e.g. the columns for an image, it is not needed to restore the columns in a linear order, as long as the full image can be updated faster than the human eye's resolution (e.g. 100 Hz).

In embodiments of the present invention, the LED driver integrated circuits (110) may control the rows and columns of the matrix configuration (130) in a non-sequential order to reduce systematic errors.

Pseudo-randomization helps reducing Moiré and aliasing artifacts: If a lighting scenario and in specific an image follows a strict sequential activation of rows (slots), it may introduce periodic patterns that interact with the LED pixel structure or other external patterns (such as camera sensors or refresh cycles for the image). A pseudo-random order can break these regular patterns, reducing visible aliasing and Moiré artifacts.

Also, perceptual flicker can be reduced. The human eye is more sensitive to structured, repetitive flicker patterns than to random or pseudo-random variations. By distributing the updates across different areas of the display like organization of LEDs in a less predictable way, perceived flicker can be reduced.

It allows also to mitigate synchronization artifacts. If LEDs are in a display-like organization for displaying lighting sequences as e.g. images, they may be operating in environments with interfering signals (e.g., PWM-controlled backlights, VR headsets, or rolling-shutter cameras). Because of that they can suffer from synchronization issues. A pseudo-random activation sequence of the rows and columns can help to desynchronize these effects, making the interaction less noticeable.

In embodiments of the present invention, a lighting system (100) may also implement a randomized switching sequence for security purposes. For example, the LED driver ICs (110) may dynamically alter the order in which rows or columns are activated, using a non-sequential or pseudo-random assignment primarily intended to enhance system-level security against unauthorized interception or manipulation of lighting patterns.

In embodiments of the present invention, each LED driver IC (110) may receive switch-order instructions from a PWM commander (110) that include a variable or pseudo-random index for activating switches (112). This varying sequence may not merely reduce visual artifacts but also complicate attempts at predicting the system's activation pattern, thereby increasing resistance to certain security threats.

In embodiments of the present invention, within a lighting system (100) having multiple LED driver ICs (110) arranged in a matrix format (130), the PWM commander (110) may embed a randomizing seed in the synchronization signal pulse lengths from the PWM clock generator (115). Each PWM responder (110) may decode the seed and use it to compute a new activation order for its assigned switches (112) before commencing the next PWM cycle. By ensuring that each cycle's switch-order changes unpredictably over time, malicious devices or methods attempting to replicate or disrupt the lighting pattern face a reduced likelihood of success.

In a second aspect, the present invention relates to an LED driver integrated circuit (110) for use in a matrix lighting system comprising a plurality of LEDs (120) arranged in a matrix configuration (130), the LED driver integrated circuit (110) comprising: a plurality of current sources (111), each current source (111) having an associated pulse width modulation channel; a plurality of switches (112) for selectively connecting LEDs (120) to a power supply or ground; a PWM clock generator (115) configured to provide a timing signal to the PWM channels; a synchronization interface (113) configured to operate in: a PWM commander mode to generate and output a synchronization signal based on the PWM clock generator (115); or a PWM responder mode to receive a synchronization signal and adjust operation of the PWM channels based on a received synchronization signal; a PWM adjustment unit (116) configured to, in the PWM responder mode, measure a pulse length of the received synchronization signal from the synchronization interface (113) and adjust at least one of the PWM clock generator (115) frequency or PWM ratios based on the measured pulse length; wherein the current sources (111) are configured to drive one or more LEDs (120) of the matrix lighting system (100), and wherein the switches (112) are configured to connect one or more LEDs (120) of the matrix lighting system (100) to a power supply or ground.

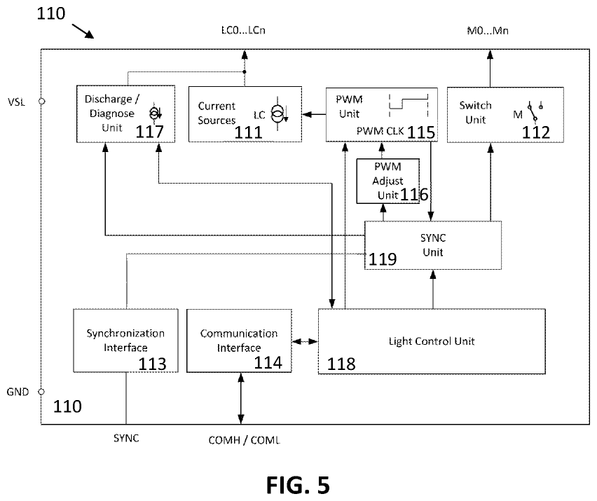

FIG. 5 shows an LED driving integrated circuit (110) according to embodiments of the invention. The diagram shows several interconnected components, each serving a specific function within the circuit. In this particular embodiment the LED driving integrated circuit (110) comprises a light control unit (118). Via the communication interface (114) the light control unit might receive from the ECU information. This information may for example indicate if the addressed LED driving IC (110) will be a PWM commander or a PWM responder. This information might be memorized. In this exemplary embodiment of the present invention the LED driving IC (110) comprises a synchronization unit (119). The light control unit (118) may be configured to program the synchronization unit (119) either in PWM commander or in PWM responder mode. The synchronization unit (119) is configured to transmit a synchronization signal in PWM commander mode or to receive the synchronization signal in PWM responder mode after the assignment of the ECU.

In this exemplary embodiment of the present invention the LED driving IC (110) comprises a PWM clock generator (115) with a PWM clock. In case the LED driving IC (110) is PWM commander, the PWM clock will be used in order to build up the synchronization signal accordingly. A PWM adjustment or a PWM clock adjustment is not needed in PWM commander mode.

In this exemplary embodiment of the present invention the LED driving IC (110) comprises a communication interface (114).

The light control unit (118) may receive lighting information from an ECU via the communication interface (114) according FIGS. 3 and 4. This might be brightness and/or color information for the LEDs controlled by the LED driving IC according FIGS. 1 and 4. The light control unit (118) might convert the lighting information to PWM information for the current sources LC (111) as well as to switch information for the switches (112) M for the LEDs controlled by the LED driving IC (110).

Alternatively, the light control unit might already receive PWM information for the LEDs controlled by the LED driving IC by the ECU. In that case also switch information must be provided by the ECU.

In embodiments of the present invention the light control unit (118) is configured to provide PWM information (PWM values) and switch information (what switch is active in a given PWM cycle) to the synchronization unit (119). The synchronization unit synchronizes the received PWM values and the switch information according to the synchronization signal as shown in FIG. 2. By doing so it is ensured that the lighting scenario is correctly displayed without flickering.

As discussed before, the LED driving ICs (110) may have a mismatch in their PWM clock frequencies, that should be compensated. The LED driving IC (110) may comprise a PWM adjustment unit (116) which is configured to adjust the PWM clock frequency to reduce or even completely remove this mismatch. This might be done by measuring the pulse length of the synchronization signal by a timer or a counter in the PWM adjustment unit (116). By doing that, information about the PWM clock frequency of the PWM commander might be derived by the PWM responder. The PWM adjustment unit (116) of the PWM responder might calculate the deviation of the PWM clock frequency of the PWM commander with its own PWM clock frequency. The deviation might be positive or negative in the range of ca+/−3%.

After the deviation is known, the PWM adjustment unit (116) might compensate the deviation.

In one embodiment the PWM clock frequency might be adjusted by the PWM responder in order to match the PWM clock frequency of the PWM commander.

In another embodiment the received PWM values from the light control unit (118) might be modified by the PWM adjustment unit (116) in the same ratio as the deviation of the PWM clock frequency.

In one embodiment, this mismatch compensation might be done in each PWM cycle. In another embodiment it might only be done from time to time. In any case, the mismatch compensation leads to a more harmonic display of the lighting scenario or picture.

In embodiments of the present invention the LED driving IC (110) comprises a PWM clock generator (115). The PWM adjustment unit (116) provides the adjusted PWM values or adjusted PWM clock to the PWM clock generator (115), to which the current sources (111) are connected. The current sources will provide the current for the connected LEDs accordingly.

In the exemplary method of the present invention the switch information provided by the light control unit (118) to the synchronization unit (119) comprises what switch is active in a given PWM period. The synchronization unit (119) synchronizes that information to the synchronization signal and provides this adjusted information to the switch unit. The selected switches (112) are then activated accordingly during the given PWM period.

A discharge circuit (117) may be connected in parallel to each of the current sources (111). The discharge circuit may comprise a current source with a smaller value or even just resistors. These current sources or resistors are switchable and might be enabled by the light control unit (118). The synchronization unit (119) may be configured to synchronize the switching of these current sources or resistors in accordance with the synchronization signal as shown in FIG. 2.

By doing so, charges from a previous PWM cycle are removed from the switches and the connected rows and columns. This avoids ghosting effects of the lighting scenario, as the LEDs might glim because of pending charges if switches are enabled in another PWM cycle with current sources being still in an off mode.

Within this discharging mode a monitoring of the connected LEDs might be done. Discharge currents and voltages may be measured and compared to thresholds. In case of a detected failure, a diagnose Unit might provide information to the light control unit (118), which may communicate this failure via the communication interface to the connected ECU.

The thresholds of the connected LEDs may be measured using the parallel current sources. These currents through these parallel current sources may be so small that they do not lead to a lighting function of the connected LEDs however, enable threshold measurements for diagnostic purposes or even derive temperature information out of the thresholds.

The light control unit (118), the synchronization unit (119), the PWM adjustment unit (116) and the PWM clock generator (115) of FIG. 5 might be realized under use of a microcontroller comprising memories, registers, timers and PWM channels. A software program in the program memory of the microcontroller might perform an algorithm to realize the previous described function.

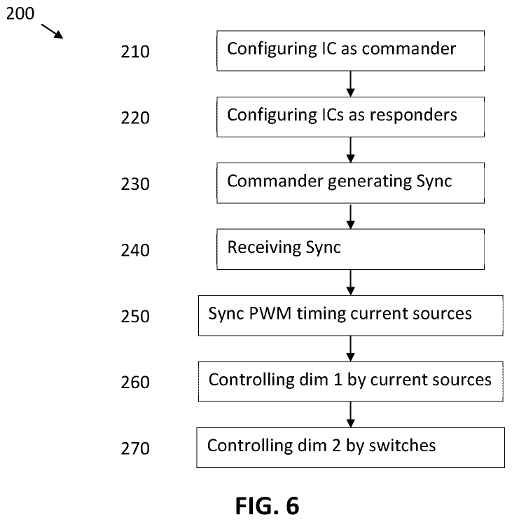

In a third aspect, the present invention relates to a method (200) of operating a lighting system (100) comprising a plurality of LED driver integrated circuits (110) arranged in a matrix configuration (130). An exemplary embodiment of such a method is shown in FIG. 6. The method comprises: configuring (210) one LED driver integrated circuit (110) as a pulse width modulation PWM commander; configuring (220) the remaining LED driver integrated circuits (110) as PWM responders; generating (230), by the PWM commander (110), a synchronization signal using the PWM clock generator (115) based on the PWM commander's clock; receiving (240), by each PWM responder (110), the synchronization signal via the synchronization interface (113); synchronizing (250) PWM timing of current sources (111) in each PWM responder (110) based on the received synchronization signal; controlling (260) a first dimension of a matrix (130) of LEDs (120) using current sources (111) from the plurality of LED driver integrated circuits (110); and controlling (270) a second dimension of the matrix (130) of LEDs (120) using switches (112) from the plurality of LED driver integrated circuits (110), wherein each LED (120) in the matrix (130) is connected between at least one current source (111) of the LED driver integrated circuits (110) and at least one switch (112) of the LED driver integrated circuits (110).

In embodiments of the present invention, the method may further comprise: activating a discharge cycle between PWM cycles; activating discharge circuits (117) during the discharge cycle to remove residual charges from the LEDs (120); and ensuring all current sources (111) are deactivated before switching states of any switches (112). This sequential operation prevents unwanted LED (120) illumination during switching transitions, providing cleaner visual output.

In embodiments of the present invention, the method may further comprise: measuring a pulse length of the synchronization signal via the synchronization interface (113) at each PWM responder (110); calculating a clock frequency deviation between the PWM commander (110) and each PWM responder (110) based on the measured pulse length; and adjusting PWM operation in each PWM responder (110) by modifying parameters of the PWM clock generator (115) or PWM ratios of the current sources (111) to compensate for the calculated deviation.

1. A lighting system comprising:
a plurality of LED driver integrated circuits, each LED driver integrated circuit comprising:
a plurality of current sources, each current source having an associated PWM channel;
a plurality of switches for selectively connecting LEDs to a power supply or ground;
a synchronization interface;
a communication interface;
a PWM clock generator configured to provide a timing signal to the PWM channels;
a plurality of LEDs arranged in a matrix configuration, wherein each LED is connected between at least one current source from the LED driver integrated circuits and at least one switch of the LED driver integrated circuits and wherein the PWM channel is configured to control current flow through one of the LEDs or string of LEDs;
wherein the current sources of the plurality of LED driver integrated circuits control a first dimension of the matrix configuration, and the switches control a second dimension of the matrix configuration; and
wherein the lighting system is configured to synchronize PWM timing across the plurality of LED driver integrated circuits, wherein one LED driver integrated circuit is configured as a PWM commander to generate a synchronization signal and remaining LED driver integrated circuits are configured as PWM responders to adjust the PWM operation based on the received synchronization signal.

2. The lighting system according to claim 1, wherein the number of LEDs controllable by the lighting system scales with the number (n) of LED driver integrated circuits according to the formula n²×LC×M, where LC is the number of current sources per LED driver integrated circuit and M is the number of switches per LED driver integrated circuit.

3. The lighting system according to claim 1, further comprising an electronic control unit connected to the communication interfaces of the plurality of LED driver integrated circuits, the electronic control unit configured to assign one LED driver integrated circuit as the PWM commander and to assign the remaining LED driver integrated circuits as the PWM responders.

4. The lighting system according to claim 1, wherein the PWM commander is configured to generate the synchronization signal with a frequency and a pulse length related to its PWM clock generator, and wherein each PWM responder is configured to synchronize the operation of its current sources and switches according to the received synchronization signal.

5. The lighting system according to claim 1, wherein each LED driver integrated circuit further comprises a discharge circuit connected in parallel to each current source, the discharge circuit configured to remove residual charges from the matrix configuration during a discharge phase synchronized with the synchronization signal.

6. The lighting system according to claim 1, wherein each LED driver integrated circuit is configured to perform diagnostics on connected LEDs during an off phase and to communicate diagnostic results via the communication interface.

7. The lighting system according to claim 1, wherein each PWM responder is configured to measure a pulse length of the received synchronization signal and adjust at least one of its PWM clock generator frequency or PWM ratios of its current sources based on the measured pulse length.

8. The lighting system according to claim 1, wherein the PWM commander is configured to encode additional information in the synchronization signal by varying the pulse length, and wherein the PWM responders are configured to decode the additional information.

9. The lighting system according to claim 1, wherein the LED driver integrated circuits are configured to control the rows and columns of the matrix configuration in a non-sequential order to reduce systematic errors.

10. An LED driver integrated circuit for use in a matrix lighting system comprising a plurality of LEDs arranged in a matrix configuration, the LED driver integrated circuit comprising:
a plurality of current sources, each current source having an associated pulse width modulation channel;
a plurality of switches for selectively connecting LEDs to a power supply or ground;
a PWM clock generator configured to provide a timing signal to the PWM channels;
a synchronization interface configured to operate in:
a PWM commander mode to generate and output a synchronization signal based on the PWM clock generator; or
a PWM responder mode to receive a synchronization signal and adjust operation of the PWM channels based on a received synchronization signal;
a PWM adjustment unit configured to, in the PWM responder mode, measure a pulse length of the received synchronization signal and adjust at least one of the PWM clock generator frequency or PWM ratios based on the measured pulse length;
wherein the current sources are configured to drive one or more LEDs of the matrix lighting system, and
wherein the switches are configured to connect one or more LEDs of the matrix lighting system to a power supply or ground.

11. The LED driver integrated circuit according to claim 10, further comprising a discharge circuit connected in parallel to each of the current sources, the discharge circuit configured to activate during intervals between PWM cycles to remove residual charges from connected LEDs.

12. The LED driver integrated circuit according to claim 10, wherein the synchronization interface is further configured to encode or decode multiple information types based on different pulse lengths of the synchronization signal.

13. A method of operating a lighting system comprising a plurality of LED driver integrated circuits arranged in a matrix configuration, the method comprising:
configuring one LED driver integrated circuit as a pulse width modulation PWM commander;
configuring remaining LED driver integrated circuits as PWM responders;
generating, by the PWM commander, a synchronization signal based on a PWM clock of the PWM commander;
receiving, by each PWM responder, the synchronization signal;
synchronizing PWM timing of current sources in each PWM responder based on the received synchronization signal;
controlling a first dimension of a matrix of LEDs using current sources from the plurality of LED driver integrated circuits; and
controlling a second dimension of the matrix of LEDs using switches from the plurality of LED driver integrated circuits,
wherein each LED in the matrix is connected between at least one current source of the LED driver integrated circuits and at least one switch of the LED driver integrated circuits.

14. The method according to claim 13, further comprising:
activating a discharge cycle between PWM cycles;
activating discharge circuits during the discharge cycle to remove residual charges from the LEDs; and
ensuring all current sources are deactivated before switching states of any switches.

15. The method according to claim 13, further comprising:
measuring a pulse length of the synchronization signal at each PWM responder;
calculating a clock frequency deviation between the PWM commander and each PWM responder based on the measured pulse length; and
adjusting PWM operation in each PWM responder to compensate for the calculated deviation.
